(19) United States
(12) Patent Application Publication
(10) Pub. No.: US 2021/0088018 A1
(43) Pub. Date: Mar. 25, 2021

(54) ENERGY STORAGE APPARATUS AND RESTART METHOD FOR ENGINE OF IDLING-STOP VEHICLE

(71) Applicant: GS Yuasa International Ltd., Kyoto-shi (JP)

(72) Inventor: Yuki IMANAKA, Kyoto-shi, Kyoto (JP)

(21) Appl. No.: 17/048,449

(22) PCT Filed: Apr. 19, 2019
(86) PCT No.: PCT/JP2019/016829

§ 371 Date: Oct. 16, 2020

(30) Foreign Application Priority Data
Apr. 24, 2018 (JP) 2018-082976

(51) Int. Cl. F02N 11/08; B60R 16/033

(52) U.S. Cl. CPC F02N 11/0862; H02J 7/00302; F02N 11/0818; B60R 16/033

(57) ABSTRACT

An energy storage apparatus for supplying electric power to auxiliaries and a starter that starts an engine of an idling-stop vehicle, the energy storage apparatus including: an energy storage device; a measurement part (current sensor) that measures a physical quantity relating to a voltage drop of the energy storage device; and a management part that manages the energy storage device. The management part executes an estimation process of estimating, based on the physical quantity, a minimum voltage of the energy storage device during restart of the engine at a predetermined time point during idling-stop of the idling-stop vehicle, and a notification process of notifying a restart request for the engine to the idling-stop vehicle when the minimum voltage is less than a predetermined threshold.

### TECHNICAL FIELD

The present invention relates to an energy storage apparatus and a restart method for an engine of an idling-stop vehicle.

### BACKGROUND ART

There has been known a vehicle (hereinafter referred to as “idling-stop vehicle”) for performing so-called idling-stop, in which the engine is automatically stopped when the vehicle is stopped. Generally, in an idling-stop vehicle, an energy storage apparatus for supplying electric power to a starter that starts an engine also serves as an energy storage apparatus for supplying electric power to auxiliaries (engine control unit (ECU), headlight, air conditioner, audio, etc.) during idling-stop.

During idling-stop, electric power is supplied to the auxiliaries from the energy storage apparatus, power generation is stopped because the engine is stopped. Hence the voltage of the energy storage apparatus (more specifically, an energy storage device provided in the energy storage apparatus) greatly drops during idling-stop depending on the power usage state of the auxiliaries. When idling-stop is ended and the engine is started (hereinafter referred to as “restart”), the voltage of the energy storage apparatus becomes lower than that before the restart due to voltage drop. Thus, when the voltage of the energy storage apparatus is greatly lowered during idling-stop, the voltage is further lowered therefrom due to the voltage drop, so that sufficient electric power cannot be supplied from the energy storage apparatus to the auxiliaries during the restart of the engine, and the operation of the auxiliaries may become unstable.

There has thus been known a technique in which, on the assumption that an ECU of a vehicle obtains a voltage value of a power storage apparatus during idling-stop and an engine is restarted at the present time point, the minimum voltage of the energy storage apparatus during restart is estimated, and when the estimated minimum voltage is less than a threshold, idling-stop is stopped to restart the engine (e.g., see Patent Document 1).

The ECU described in Patent Document 1 obtains a detection value of a voltage of a battery during idling-stop and predicts a minimum voltage Vmin (corresponding to the minimum voltage) associated with the voltage drop of the battery in a case where the engine is assumed to have been restarted at the present time point. When the minimum voltage Vmin is equal to or less than a threshold voltage Vth (corresponding to the threshold), the ECU immediately stops idling-stop control and immediately starts the engine.

### PRIOR ART DOCUMENT

### Patent Document

Patent Document 1: JP-A-2012-172567

### SUMMARY OF THE INVENTION

### Problems to be Solved by the Invention

In general, when the ECU obtains the voltage value of the energy storage apparatus, the energy storage apparatus measures the voltage value, and the measured voltage value is transmitted to the ECU by communication. However, as shown in FIG. 12, the ECU generally communicates with many pieces of in-vehicle equipment in order, and hence there is a time lag until the ECU receives the voltage value measured by the energy storage apparatus.

When there is a time lag, an actual minimum voltage may be lower than the estimated minimum voltage because electric power is consumed by the auxiliaries during a time-lag period. Thus, even if the engine is immediately restarted when the minimum voltage below the threshold is estimated, the operation of the auxiliaries may become unstable during restart.

The present specification discloses a technique for reducing the possibility that operations of auxiliaries become unstable due to the voltage drop of an energy storage device accompanying the restart of an engine of an idling-stop vehicle.

### Means for Solving the Problems

An energy storage apparatus for supplying electric power to auxiliaries and a starter that starts an engine of an idling-stop vehicle includes: an energy storage device; a measurement part that measures a physical quantity relating to a voltage drop of the energy storage device; and a management part that manages the energy storage device. The management part executes an estimation process of estimating, based on the physical quantity, a minimum voltage of the energy storage device during restart of the engine at a predetermined time point during idling-stop of the idling-stop vehicle, and a notification process of notifying a restart request for the engine to the idling-stop vehicle when the minimum voltage is less than a predetermined threshold.

### Advantages of the Invention

It is possible to reduce the possibility that the operations of the auxiliaries become unstable due to the voltage drop of the energy storage device accompanying the restart of the engine of an idling-stop vehicle.

### BRIEF DESCRIPTION OF THE DRAWINGS

FIG. 1 is a schematic diagram of an energy storage apparatus according to a first embodiment and an idling-stop vehicle mounted with the energy storage apparatus.

FIG. 2 is an exploded perspective view of the energy storage apparatus.

FIG. 3(a) is a plan view of the energy storage device shown in FIG. 2, and FIG. 3(b) is a sectional view taken along line A-A in FIG. 3(a).

FIG. 4 is a perspective view showing a state where an energy storage device is accommodated in the body of FIG. 1.

FIG. 5 is a perspective view showing a state where busbars are mounted on the energy storage device of FIG. 4.

FIG. 6 is a block diagram showing an electrical configuration of the energy storage apparatus.

FIG. 7 is a graph for explaining voltage drop caused by power consumption and a voltage drop caused by the polarization of the energy storage device.

FIG. 8(A) is a graph showing a change in a current flowing in the energy storage device that supplies electric power to the idling-stop vehicle, and FIG. 8(B) is a graph showing a change in the voltage of the energy storage device.

FIG. 9 is a graph showing a change in the voltage of the energy storage device that supplies electric power to the idling-stop vehicle.

FIG. 10 is a graph for explaining voltage drop caused by power consumption and voltage drop caused by polarization of the energy storage device at a time point of estimation of the minimum voltage.

FIG. 11 is a flowchart of a request process.

FIG. 12 is a sequence chart showing a procedure in which the ECU of the vehicle communicates with in-vehicle equipment.

### MODE FOR CARRYING OUT THE INVENTION

### Summary of Present Embodiment

An energy storage apparatus for supplying electric power to auxiliaries and a starter that starts an engine of an idling-stop vehicle includes: an energy storage device; a measurement part that measures a physical quantity relating to a voltage drop of the energy storage device; and a management part that manages the energy storage device. The management part executes an estimation process of estimating, based on the physical quantity, a minimum voltage of the energy storage device during restart of the engine at a predetermined time point during idling-stop of the idling-stop vehicle, and a notification process of notifying a restart request for the engine to the idling-stop vehicle when the minimum voltage is less than a predetermined threshold.

The management part provided in the energy storage apparatus, not the ECU of the idling-stop vehicle, estimates the minimum voltage. Since the physical quantity measured by the measurement part is output to the management part in real time, when the management part provided in the energy storage apparatus estimates the minimum voltage, a time lag between the measurement of the physical quantity and the estimation of the minimum voltage can be reduced as compared to the case where the minimum voltage is estimated by the ECU. Hence the minimum voltage can be estimated accurately.

The energy storage apparatus notifies a restart request for the engine to the idling-stop vehicle when the minimum voltage is less than a predetermined threshold. Therefore, even in a case where the management part provided in the energy storage apparatus estimates the minimum voltage, the engine can be restarted when the minimum voltage drops below the threshold. In this case, the minimum voltage can be accurately estimated by the energy storage apparatus as described above, the actual minimum voltage does not differ significantly from the estimated minimum voltage, and the auxiliaries can be stably operated even during the restart of the engine.

It is thus possible to reduce the possibility that the operations of the auxiliaries become unstable due to the voltage drop of the energy storage device accompanying the restart of the engine of the idling-stop vehicle.

The management part may estimate a voltage drop during the restart of the engine based on the physical quantity and may estimate the minimum voltage by subtracting a voltage drop during the restart of the engine from the open-circuit voltage of the energy storage device at the time point.

For example, it is conceivable to estimate the minimum voltage by setting the voltage drop during restart to a fixed value and subtracting the voltage drop during restart (fixed value) from the open-circuit voltage (OCV) of the energy storage device at the time point described above (i.e., the time point at which the minimum voltage is estimated during idling-stop). However, since the voltage drop during restart is not constant, when the voltage drop during restart is set to a fixed value, the estimation accuracy of the minimum voltage decreases. According to the above energy storage apparatus, the voltage drop during restart is estimated based on the physical quantity relating to the voltage drop of the energy storage device, so that the minimum voltage can be accurately estimated as compared to when the voltage drop during restart is set to a fixed value.

The physical quantity may include a current value of a current flowing in the energy storage device, and the management part may estimate the open-circuit voltage of the energy storage device at the time point based on the current value measured by the measurement part in the estimation process.

As a method of knowing the open-circuit voltage of the energy storage device at the time point described above, a method of actually opening the circuit and measuring the voltage of the energy storage device can be considered. However, the energy storage device needs to supply electric power to the auxiliaries during idling-stop, and hence the voltage of the energy storage device cannot be measured by actually opening the circuit during idling-stop. According to the above energy storage apparatus, the open-circuit voltage of the energy storage device at the time point is estimated based on the current value measured by the measurement part, rather than actually measuring the voltage by opening the circuit, so that the minimum voltage can be estimated even when the open-circuit voltage cannot be measured during idling-stop.

In the estimation process, the management part may estimate, in the estimation process, a voltage drop caused by the concentration polarization of the energy storage device at the time point based on the physical quantity and may estimate the voltage drop during the restart of the engine based on the estimated voltage drop.

There is hysteresis in concentration polarization, and the voltage drop caused by concentration polarization at the time point described above influences voltage drop during the restart of the engine. According to the above energy storage apparatus, the voltage drop during restart is estimated based on the voltage drop caused by the concentration polarization at the time point described above, whereby the voltage drop during restart can be accurately estimated as compared to the case where the voltage drop during restart is not based on the voltage drop caused by the concentration polarization at the time point described above.

The energy storage device may be a lithium ion battery.

The lithium ion battery has a large capacity (has a high energy density) and may thus supply electric power to many auxiliaries. Thus, the voltage drop of the lithium ion battery may become large due to power consumption by many auxiliaries during idling-stop. When the voltage drop becomes large, the engine may not be able to be restarted. When the engine cannot be restarted, the battery may be replaced. Lithium ion batteries are generally expensive, and hence the replacement of a lithium ion battery is typically not desired. According to the energy storage apparatus, when the minimum voltage of the energy storage device during the restart of the engine is less than a predetermined threshold, a restart request for the engine is notified to the idling-stop vehicle, so that the replacement of the lithium ion battery can be prevented. Since the lithium ion battery has a battery monitoring apparatus, it is not necessary to separately develop and mount a monitoring substrate in implementing the present invention.

The invention disclosed by the present specification can be realized in various modes such as an apparatus, a method, a computer program for realizing the apparatus or the method, and a recording medium on which the computer program is recorded.

### First Embodiment

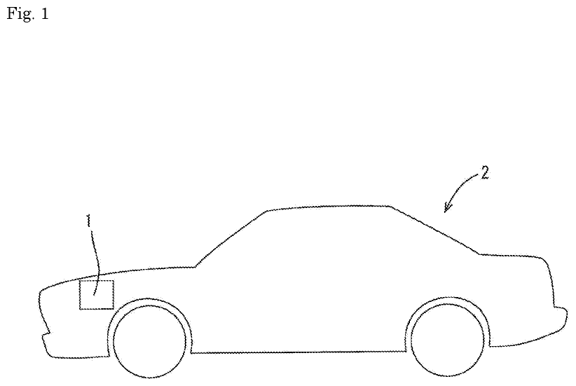

An embodiment will be described with reference to FIGS. 1 to 11.

(1) Configuration of Energy Storage Apparatus

An energy storage apparatus 1 according to a first embodiment will be described with reference to FIG. 1. In FIG. 1, a vehicle 2 is an idling-stop vehicle. An energy storage apparatus 1 is mounted on an idling-stop vehicle 2 and supplies electric power to a starter that starts an engine of the idling-stop vehicle 2 and auxiliaries (ECU, headlight, air conditioner, audio, etc.).

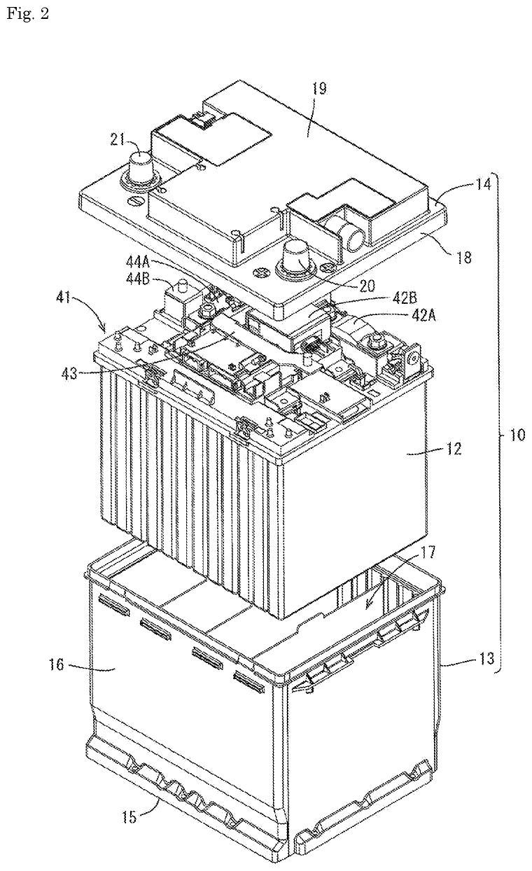

As shown in FIG. 2, the energy storage apparatus 1 includes an outer case 10 and a plurality of energy storage devices 12 accommodated inside the outer case 10. The outer case 10 includes a body 13 made of a synthetic resin material and a lid 14. The body 13 has a bottomed cylindrical shape and is made up of a bottom surface 15 having a rectangular shape in a plan view and four side-surfaces 16 rising from the four sides of the bottom surface 15 to form a cylindrical shape. An upper opening 17 is formed at an upper end portion by the four side-surfaces 16.

The lid 14 is rectangular in the plan view, and the frame body 18 extends downward from the four sides of the lid 14. The lid 14 closes an upper opening 17 of the body 13. A protrusion 19 having a substantially T-shape in the plan view is formed on the upper surface of the lid 14. A positive external terminal 20 is fixed to one corner of two portions where the protrusion 19 is not formed on the upper surface of the lid 14, and a negative external terminal 21 is fixed to the other corner.

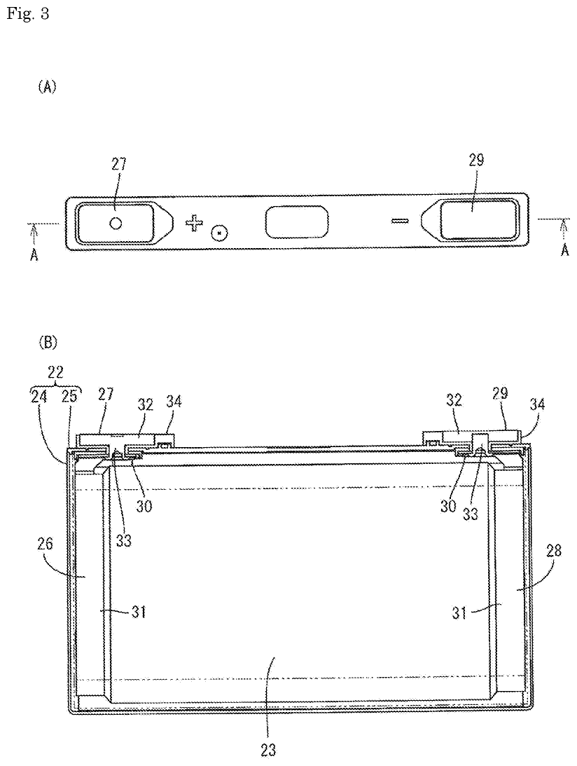

The energy storage device 12 is a rechargeable secondary battery and is specifically a lithium ion battery, for example. As shown in FIGS. 3(a) and 3(b), the energy storage device 12 has an electrode assembly 23 and a nonaqueous electrolyte accommodated in a rectangular parallelepiped case 22. The case 22 is made up of a case body 24 and a cover 25 that closes an opening at the upper portion of the case body 24.

In the electrode assembly 23, although not shown in detail, a separator made of a porous resin film is disposed between a negative electrode element obtained by applying an active material to a substrate made of copper foil and a positive electrode element obtained by applying an active material to a substrate made of aluminum foil. Each of these is a belt-like shape, and is wound in a flat shape so as to be accommodated in the case body 24 in a state where the negative electrode element and the positive electrode element are displaced from each other on the opposite side in the width direction with respect to the separator.

A positive electrode terminal 27 is connected to the positive electrode element via a positive current collector 26. A negative electrode terminal 29 is connected to the negative electrode element via a negative current collector 28. The positive current collector 26 and the negative current collector 28 each have a flat base 30 and a leg 31 extending from the base 30. A through-hole is formed in the base 30. The leg 31 is connected to the positive electrode element or negative electrode element. The positive electrode terminal 27 and the negative electrode terminal 29 each have a terminal body 32 and a shaft 33 projecting downward from the center part of its lower surface. The terminal body 32 and the shaft 33 in the positive electrode terminal 27 of the above terminals are integrally formed using aluminum (single material). In the negative electrode terminal 29, the terminal body 32 is made of aluminum, the shaft 33 is made of copper, and these parts are assembled. The terminal bodies 32 in the positive electrode terminal 27 and the negative electrode terminal 29 are disposed at both ends of the cover 25 via gaskets 34 made of an insulating material and are exposed outward from the gaskets 34.

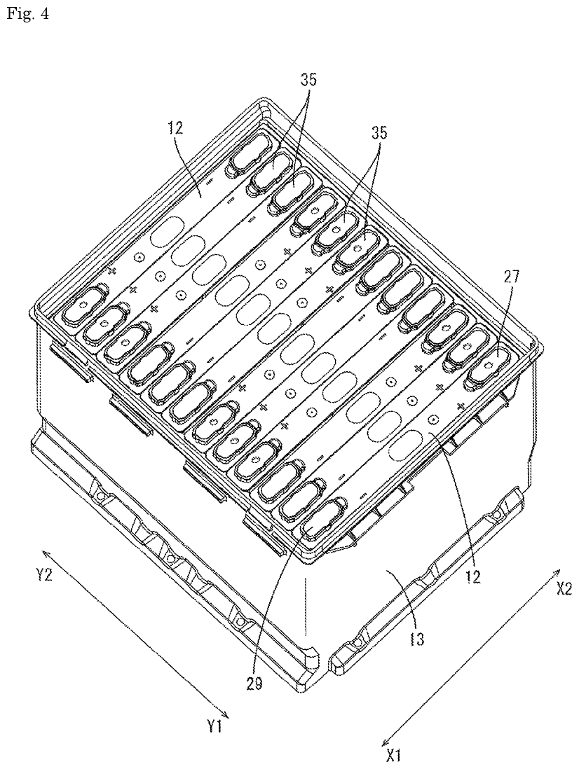

As shown in FIG. 4, a plurality of (e.g., 12) energy storage devices 12 are accommodated in the body 13 in parallel in the width direction. Here, with three storage devices 12 arranged as a set from one end side to the other end side of the body 13 (direction from arrow Y1 to arrow Y2), the energy storage devices 12 are arranged so that the terminal polarities of the adjacent storage devices 12 are the same in the same set, and the terminal polarities of the adjacent storage devices 12 are opposite in the adjacent sets. In the three energy storage devices 12 (first set) located closest to the arrow Y1 side, the arrow X1 side is a negative electrode, and the arrow X2 side is a positive electrode. In the three energy storage devices 12 (second set) adjacent to the first set, the arrow X1 side is a positive electrode, and the arrow X2 side is a negative electrode. Further, in a third set adjacent to the second set, the arrangement is the same as in the first set, and in a fourth set adjacent to the third set, the arrangement is the same as in the second set.

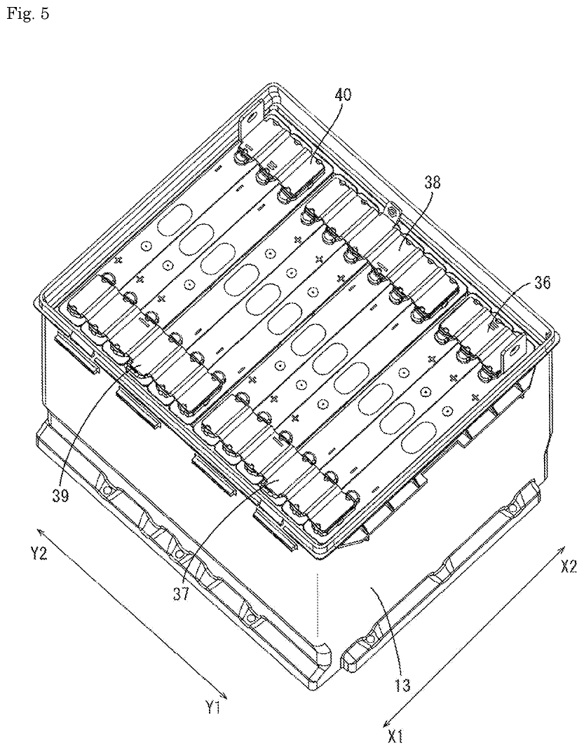

As shown in FIG. 5, terminal busbars (connection members) 36 to 40 as conductive members are connected to the positive electrode terminal 27 and the negative electrode terminal 29 by welding. On the arrow X2 side of the first set, the group of the positive electrode terminals 27 is connected by a first busbar 36. Between the first set and the second set, the group of the negative electrode terminals 29 in the first set and the group of the positive electrode terminals 27 in the second set are connected by a second busbar 37 on the arrow X1 side. Between the second set and the third set, the group of the negative electrode terminals 29 in the second set and the group of the positive electrode terminals 27 in the third set are connected by a third busbar 38 on the arrow X2 side. Between the third set and the fourth set, the group of the negative electrode terminals 29 in the third set and the group of the positive electrode terminals 27 in the fourth set are connected by a fourth busbar 39 on the arrow X1 side. On the arrow X2 side of the fourth set, the group of the negative electrode terminals 29 is connected by a fifth busbar 40.

Referring also to FIG. 2, the first busbar 36 located at one end of electrical flow is connected to the positive external terminal 20 via first electronic equipment 42A (e.g., a fuse), second electronic equipment 42B (e.g., a relay), the busbar 43, and a busbar terminal (not shown). The fifth busbar 40 located at the other end of the electric flow is connected to the negative external terminal 21 via busbars 44A, 44B and a negative electrode busbar terminal (not shown). As a result, each energy storage device 12 can be charged and discharged via the positive external terminal 20 and the negative external terminal 21. The electronic equipment 42A, 42B and the busbars 43, 44A, 44B for connecting electric components are attached to a circuit board unit 41 disposed above a plurality of stacked energy storage devices 12. The busbar terminal is disposed on the lid 14.

(2) Electrical Configuration of Energy Storage Device

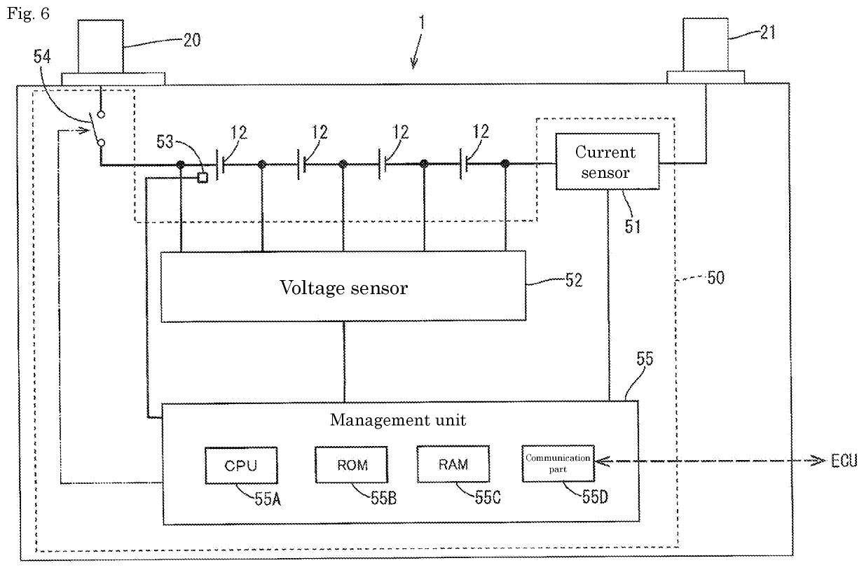

As shown in FIG. 6, the energy storage apparatus 1 includes the plurality of energy storage devices 12 described above, and a battery management apparatus 50 (battery management system (BMS)) that manages the energy storage devices 12.

The BMS 50 is mounted on the circuit board unit 41 shown in FIG. 2. The BMS 50 includes a current sensor 51 (an example of the measurement part), a voltage sensor 52 (an example of the measurement part), a temperature sensor 53 (an example of the measurement part), a relay 54, and a management part 55.

The current sensor 51 is connected in series with the energy storage device 12, measures a current value I [A] of a current flowing in the energy storage device 12, and outputs the measured current value to the management part 55. The voltage sensor 52 is connected in parallel to each energy storage device 12, measures a voltage value V [V], which is a terminal voltage of each energy storage device 12, and outputs the measured voltage value to the management part 55. The current value I and the voltage value V are each an example of the physical quantity.

The temperature sensor 53 is provided in any one of the energy storage devices 12. The temperature sensor 53 measures a temperature (an example of the physical quantity) of the energy storage device 12 and outputs the measured temperature to the management part 55. The temperature sensor 53 may be provided in each of two or more energy storage devices 12.

The relay 54 is connected in series with the energy storage device 12. The relay 54 protects the energy storage device 12 from overcharge and overdischarge and is opened and closed by the management part 55.

The management part 55 is operated by electric power supplied from the energy storage device 12 and includes a central processing unit (CPU) 55A, a read-only memory (ROM) 55B, a random-access memory (RAM) 55C, a communication part 55D, and the like. The communication part 55D communicates with an engine control unit (ECU) of the vehicle. The CPU 55A manages each part of the energy storage apparatus 1 by executing various programs stored in the ROM 55B.

The management of the energy storage device 12 by the management part 55 includes a process of estimating the state of charge (SOC) of the energy storage device 12, a process of opening the relay 54 to protect the energy storage device 12 when the overcharge or overdischarge of the energy storage device 12 is predicted, a process of estimating the state of deterioration of the energy storage device 12, and the like. In addition to the above management, the management part 55 executes a request process, described later, when the idling-stop is started.

The management part 55 may be provided with an application specific integrated circuit (ASIC), a field-programmable gate array (FPGA), or the like in place of the CPU 55A or in addition to the CPU 55A.

(3) Voltage Drop of Energy Storage Device

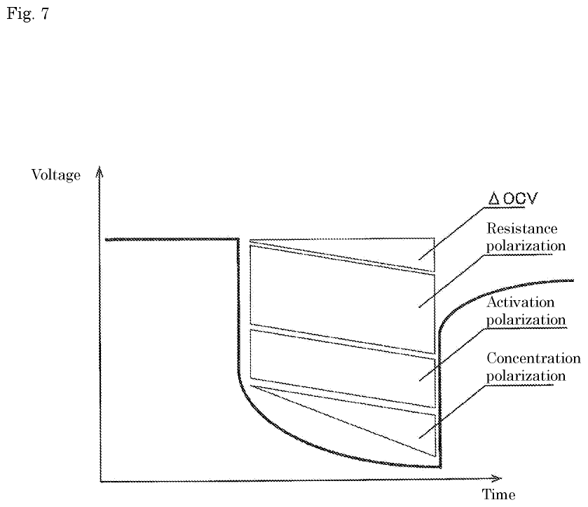

With reference to FIG. 7, a description will be given of the voltage drop of the energy storage device 12 when electric power is supplied from the energy storage device 12 to equipment such as the starter and the auxiliaries. The voltage drop of the energy storage device 12 when electric power is supplied from the energy storage device 12 to the apparatus includes voltage drop ΔOCV caused by the power consumption of the equipment and voltage drop caused by the polarization (resistance polarization, activation polarization, and concentration polarization) of the energy storage device 12.

The resistance polarization is polarization that occurs due to electrical resistance in an electrolyte solution, an electrode, an electrical contact, or the like. The activation polarization is polarization that occurs because a reactant is excited from a ground state to a high energy state in order to cause chemical reaction at the electrode surface. The concentration polarization is polarization that occurs due to a local decrease in the concentration of the reactant caused by chemical reaction at the electrode surface.

(4) Discharge Current and Voltage Drop of Energy Storage Device at Idling-Stop

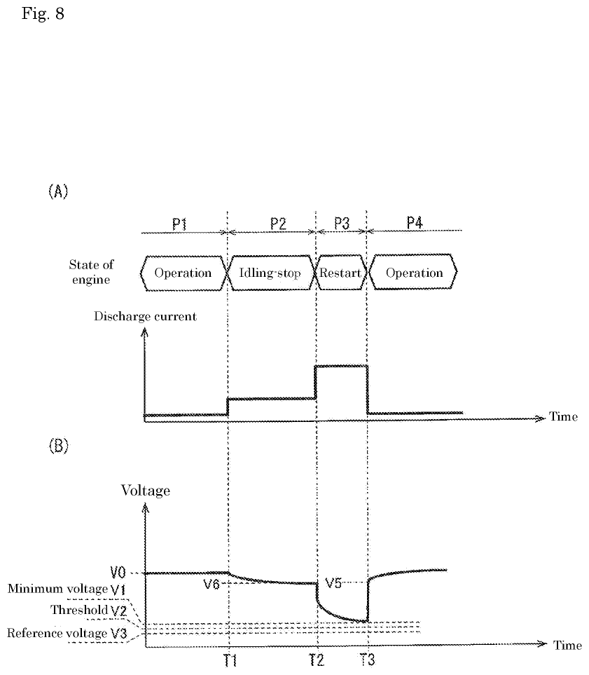

As shown in FIG. 8, in a period P1 during which the engine is in operation, electric power is supplied to the auxiliaries from a generator (alternator) using the engine of the vehicle as a power source, so that electric power is not supplied from the energy storage device 12 to the auxiliaries. However, a minute dark current flows in the energy storage device 12 even when electric power is not supplied to the auxiliaries, and hence the current flowing in the energy storage device 12 does not become 0 completely.

When the idling-stop is started at time point T1, the engine is stopped. When the engine is stopped, electric power is not supplied from the alternator to the auxiliaries, so that electric power is supplied from the energy storage device 12 to the auxiliaries in a period P2 during idling-stop. When electric power is supplied from the energy storage device 12 to the auxiliaries, the voltage of the energy storage device 12 drops due to the voltage drop caused by the power consumption of the auxiliaries and voltage drop caused by polarization.

In the example shown in FIG. 8, the restart of the engine is started at time point T2. When the restart of the engine is started, a large current (e.g., a current of 300 A or more) is supplied from the energy storage device 12 to the starter of the vehicle 2 in a period P3 during the restart of the engine, and the restart of the engine is completed at time point T3.

When the restart of the engine is completed at time point T3, the current does not flow from the energy storage device 12 to the starter, thereby eliminating the voltage drop caused by polarization. Therefore, the voltage of the energy storage device 12 immediately after the restart of the engine recovers from a voltage V0 at time point T1 when the idling-stop is started to a voltage V5 reduced by the voltage corresponding to the current consumed by the auxiliaries and the starter during the periods P2, P3. Thereafter, the energy storage device 12 is charged by the alternator, whereby the voltage of the energy storage device 12 is recovered to the voltage V0 at time point T1.

(5) Notification of Restart Request for Engine During Idling-Stop by Management Part

With reference to FIG. 8, a description will be given of notification of a restart request for the engine during idling-stop by the management part 55. When the idling-stop is started, the management part 55 estimates a minimum voltage V1 of the energy storage device 12 during restart on the assumption that the engine is restarted at a present time point (an example of the predetermined time point) at regular time intervals (an example of the estimation process).

When the estimated minimum voltage V1 is less than a threshold V2, the management part 55 notifies the ECU of the idling-stop vehicle 2 of a restart request for immediately restarting the engine in order to prevent the operation of the ECU from becoming unstable during restart (an example of the notification process). The threshold V2 is a voltage value higher than a reference voltage V3 required for stably operating the ECU. In the following description, the estimation process and the notification process are collectively referred to as a request process.

(5-1) Estimation of Minimum Voltage

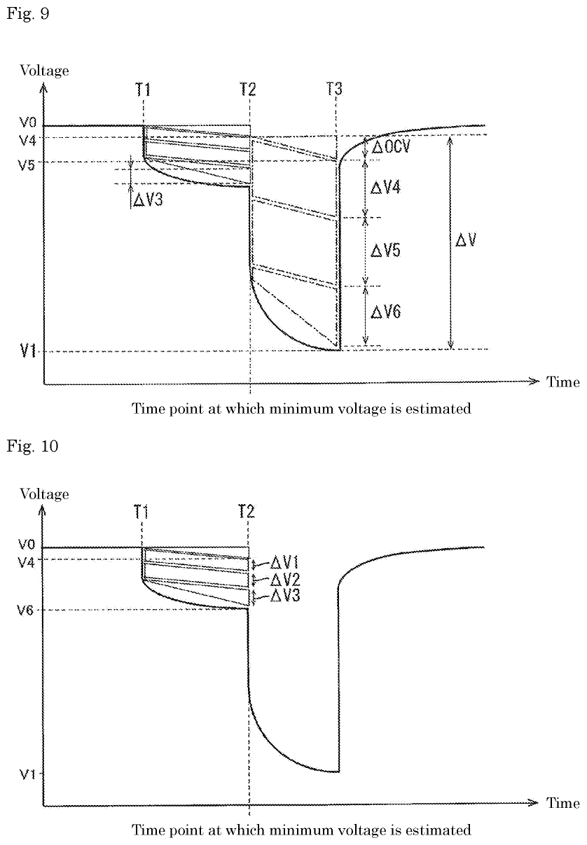

The estimation of the minimum voltage V1 will be described with reference to FIG. 9. It is assumed here that time point T2 shown in FIG. 9 is the present time point. In FIG. 9, ΔV3 indicates the voltage drop caused by the concentration polarization at the present time point.

The management part 55 estimates an open-circuit voltage (OCV) V4 of the energy storage device 12 at the present time point, estimates the voltage drop ΔV of the energy storage device 12 during the restart of the engine on the assumption that the engine is restarted at the present time point, and estimates the minimum voltage V1 by subtracting the voltage drop ΔV during restart from the open-circuit voltage V4 of the energy storage device 12 at the present time point.

The estimation of the open-circuit voltage V4 of the energy storage device 12 at the present time point will be described. The open-circuit voltage V4 corresponds to a voltage reduced by a voltage corresponding to the current consumed by the auxiliaries during the period P2 from the voltage V0 at time point T1 when the idling-stop is started.

Since electric power needs to be supplied from the energy storage device 12 to the auxiliaries during idling-stop, the voltage of the energy storage device 12 cannot be measured by actually opening the circuit. Thus, the management part 55 estimates the open-circuit voltage V4 from the SOC of the energy storage device 12 at the present time point. Specifically, the management part 55 always estimates the SOC of the energy storage device 12 by the current integration method. In the current integration method, the charge-discharge current of the energy storage device 12 is constantly measured by the current sensor 51 to measure the amount of electric power flowing in and out of the energy storage device 12, and the amount is adjusted from an initial capacity to estimate the SOC. There is a relatively accurate correlation between the SOC and the open-circuit voltage (OCV) of the energy storage device 12. Therefore, the open-circuit voltage V4 can be estimated with relatively high accuracy from the SOC at the present time point.

The ROM 55B stores an OCV-SOC table representing a correlation between the OCV and the SOC. The management part 55 estimates the open-circuit voltage V4 of the energy storage device 12 at the present time point by specifying the voltage corresponding to the SOC at the present time point from the table. That is, the management part 55 estimates the open-circuit voltage V4 of the energy storage device 12 at the present time point based on the integrated value of the current value measured by the current sensor 51.

The estimation of the voltage drop ΔV during restart will be described. The voltage drop ΔV during restart is estimated as the sum of a voltage drop ΔOCV caused by the current consumption of the starter during the restart of the engine and the voltage drop caused by the polarization of the energy storage device 12 during the restart of the engine (voltage drop ΔV4 caused by resistance polarization, voltage drop ΔV5 caused by activation polarization, and voltage drop ΔV6 caused by concentration polarization).

There is hysteresis in concentration polarization, and a voltage drop ΔV6 caused by the concentration polarization during the restart of the engine is influenced by concentration polarization at the present time point. Therefore, the management part 55 estimates the voltage drop ΔV during restart in consideration of the influence of the concentration polarization at the present time point. A method A and a method B described below can be considered as methods for estimating the voltage drop ΔV during restart in consideration of the influence of the concentration polarization at the present time point. It can be appropriately determined which of these methods is to be used.

(Method A)

Method A is a method of estimating the voltage drop ΔV during restart from a table representing a correspondence relationship between the voltage drop ΔV3 caused by the concentration polarization at the present time point and the voltage drop ΔV during restart. (alternatively, an approximate expression for calculating the voltage drop ΔV during restart from the voltage drop ΔV3 caused by the concentration polarization at the present time point)

In Method A, a developer of the energy storage apparatus 1 performs an experiment in advance to create the table described above and stores the created table into the ROM 55B. Specifically, the developer sequentially creates a plurality of states, in each of which the voltage drop ΔV3 caused by concentration polarization differs, as the state of the energy storage device 12 and measures the voltage drop ΔV during restart for each state. From the result of the experiment, the developer creates a table representing the correspondence relationship between the voltage drop ΔV3 caused by the concentration polarization at the present time point and the voltage drop ΔV during restart and stores the created table into the ROM 55B.

The management part 55 estimates the voltage drop ΔV3 caused by the concentration polarization at the present time point and estimates the voltage drop ΔV during restart by specifying the voltage drop ΔV during restart corresponding to the estimated voltage drop ΔV3 from the table.

The estimation of the voltage drop ΔV3 caused by the concentration polarization at the present time point will be described with reference to FIG. 10. As shown in Equation 1 below, the voltage drop ΔV3 can be estimated by subtracting the sum of the voltage V6 of the energy storage device 12 at the present time point, the voltage drop ΔV1 caused by resistance polarization during idling-stop, and the voltage drop ΔV2 caused by activation polarization from the open-circuit voltage V4 of the energy storage device 12 at the current time:

ΔV3=V4−V6−(ΔV1+ΔV2) Eq. 1

The method of estimating the open-circuit voltage V4 of the energy storage device 12 at the present time point is the same as described above, and a description thereof will thus be omitted.

The voltage V6 is a closed-circuit voltage (CCV) of the energy storage device 12 at the present time point measured by the voltage sensor 52. The voltage V6 is measured while the circuit is not opened. Hence the voltage V6 can be measured even during idling-stop. The voltage V6 corresponds to a voltage obtained by subtracting an amount of voltage caused by the polarization at the present time point (voltage drop ΔV1 caused by resistance polarization, voltage drop ΔV2 caused by activation polarization, and voltage drop ΔV3 caused by concentration polarization) from the open-circuit voltage V4 of the energy storage device 12 at the present time point.

The sum (ΔV1+ΔV2) of the voltage drop ΔV1 and the voltage drop ΔV2 during idling-stop can be obtained from Equation 2 below:

Sum=I×R Eq. 2

In the above equation 2, R [Ω] is the internal resistance value of the energy storage device 12, and I [A] is the current value measured by the current sensor 51 during idling-stop (e.g., the average value of the current values measured by the current sensor 51 during idling-stop). An internal resistance value R increases as the energy storage device 12 deteriorates. Therefore, the management part 55 estimates the internal resistance value R and calculates the sum by using the estimated internal resistance value R. When the deterioration of the internal resistance value R is not considered, the internal resistance value R may be stored into the ROM 55B as a fixed value.

To be exact, the voltage drop ΔV1 caused by the resistance polarization and the voltage drop ΔV2 caused by activation polarization also depend on the temperature. Therefore, the sum of these values may be estimated in consideration of the temperature.

(Method B)

Method B estimates ΔOCV and ΔV4 to ΔV6 individually during the restart of the engine and sums these amounts to estimate the voltage drop ΔV during restart. As for ΔV4 and ΔV5, the sum of these amounts is estimated. As described above, the voltage drop ΔV6 caused by the concentration polarization during the restart of the engine is influenced by the concentration polarization at the present time point. Thus, in order to estimate ΔV6, the voltage drop ΔV3 caused by the concentration polarization at the present time point is also estimated in Method B. A method of estimating ΔV3 is the same as in Method A.

(a) Estimation of Voltage Drop ΔOCV Caused by Current Consumption During Restart of Engine

When the engine is restarted, a current flows from the energy storage device 12 to the starter of the vehicle. The voltage drop caused by the current consumed by the starter is substantially constant. Therefore, the developer of the energy storage apparatus 1 measures the open-circuit voltage V4 immediately before the restart of the engine and the open-circuit voltage V5 immediately after the restart of the engine by experiments in advance and stores the difference between the measured voltages into the ROM 55B as an estimated value of a voltage drop caused by current consumption during the restart of the engine. The management part 55 uses the estimated value stored in the ROM 55B as the estimated value of the voltage drop ΔOCV caused by the current consumption during the restart of the engine.

(b) Estimation of Sum (ΔV4+ΔV5) of Voltage Drop Caused by Resistance Polarization and Voltage Drop Caused by Activation Polarization

The sum of the voltage drop ΔV4 and the voltage drop ΔV5 can be obtained from Equation 2 described above. However, in Method B, the estimated value of the current value of the current flowing in the starter during restart is used as the current value I. The current value of the current flowing in the starter is substantially constant. Hence the developer measures the current value of the current flowing in the starter by experiment in advance and stores the measured value into the ROM 55B. The management part 55 uses the current value stored in the ROM 55B as an estimated value of the current value I.

(c) Estimation of Voltage Drop ΔV6 Caused by Concentration Polarization During Restart of Engine

The management part 55 calculates the voltage drop ΔV6 from the voltage drop ΔV3 caused by the concentration polarization at the present time point by using an ion diffusion equation (Butler-Volmer equation, Nernst-Planck equation, etc.) or an equivalent circuit model. The calculation of each of electrode reactions, such as a charge transfer reaction and diffusion, is complicated and hence the CPU 55A of the management part 55 often lacks arithmetic processing capability. Thus, Method A described above may be used when the arithmetic processing capability of the CPU 55A is insufficient.

(5-2) Request Process

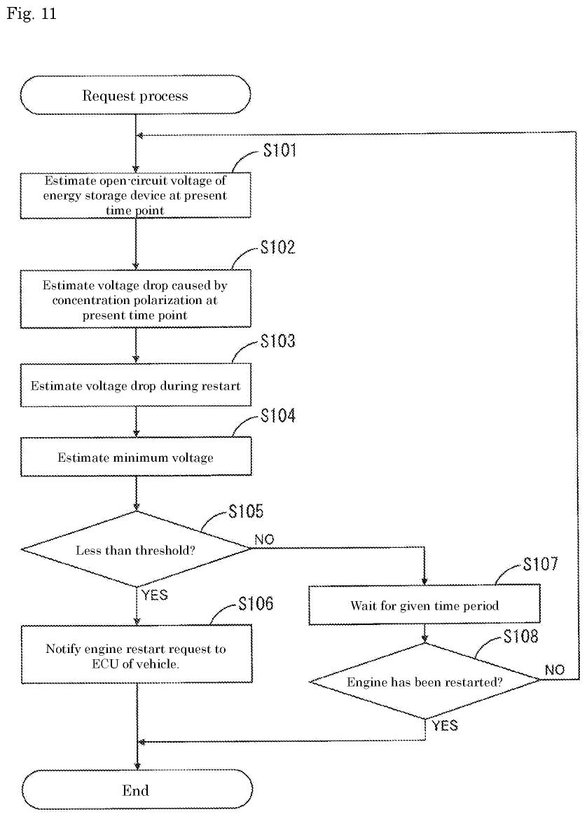

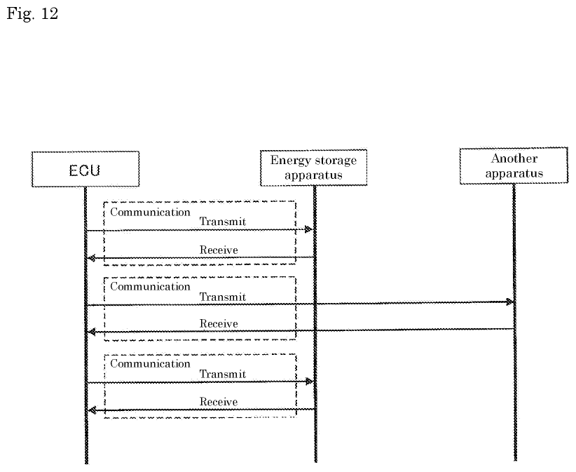

The request process executed by the management part 55 will be described with reference to FIG. 11. The present process is started when the management part 55 receives a signal indicating the start of the idling-stop from the ECU of the vehicle.

In S101, the management part 55 estimates the open-circuit voltage V4 of the energy storage device 12 at the present time point.

In S102, the management part 55 estimates the voltage drop ΔV3 caused by the concentration polarization at the present time point.

In S103, the management part 55 estimates the voltage drop ΔV during restart on the assumption that the engine is restarted at the present time point. The voltage drop ΔV may be estimated by Method A described above or by Method B described above. These methods may both be used for estimation. In S104, the management part 55 estimates the minimum voltage V1 of the energy storage device 12 being restarted by subtracting the voltage drop ΔV during restart estimated in S103 from the open-circuit voltage V4 of the energy storage device 12 at the present time point estimated in S101.

In S105, the management part 55 determines whether or not the minimum voltage V1 is less than the threshold V2, and the management part 55 proceeds to S106 when the minimum voltage V1 is less than the threshold V2, and proceeds to S107 when the minimum voltage V1 is equal to or greater than the threshold V2.

In S106, the management part 55 notifies the restart request for the engine to the ECU of the vehicle.

In S107, the management part 55 waits for a given time period, and proceeds to S108 when the given time period has elapsed.

In S108, the management part 55 determines whether the engine has been restarted. Specifically, for example, the management part 55 receives a signal representing the operating state of the engine from the ECU of the vehicle at regular time intervals and determines from the signal whether or not the engine has been restarted. When the engine has not been restarted, the management part 55 returns to S101 and repeats the process, and when the engine has been restarted, the management part 55 ends the present process.

(6) Effects of Embodiment

According to the energy storage apparatus 1, the management part 55 provided in the energy storage apparatus 1, not the ECU of the idling-stop vehicle 2, estimates the minimum voltage V1. Since the current value measured by the current sensor 51 is output to the management part 55 in real time, when the management part 55 estimates the minimum voltage V1, a time lag between the measurement of the current value and the estimation of the minimum voltage V1 can be reduced as compared to the case where the estimation is performed by the ECU. Hence the minimum voltage V1 can be estimated accurately.

According to the energy storage apparatus 1, a restart request for the engine to the idling-stop vehicle 2 is notified when the minimum voltage V1 is less than the threshold V2. Therefore, even in a case where the management part 55 provided in the energy storage apparatus 1 estimates the minimum voltage V1, the engine can be restarted when the minimum voltage V1 drops below the threshold V2. Since the minimum voltage V1 can be accurately estimated by the energy storage apparatus 1 as described above, the actual minimum voltage does not differ significantly from the estimated minimum voltage V1, and the ECU can be stably operated even during the restart of the engine.

Therefore, according to the energy storage apparatus 1, it is possible to reduce the possibility that the operation of the ECU becomes unstable due to the voltage drop of the energy storage device 12 accompanying the restart of the engine of the idling-stop vehicle 2.

According to the energy storage apparatus 1, the management part 55 for managing the energy storage device 12 executes the process of notifying the restart request for the engine. For example, there is an energy storage apparatus provided with a lead-acid battery as an energy storage device, but generally, the energy storage apparatus provided with the lead-acid battery does not include a controller. Thus, when the energy storage apparatus provided with the lead-acid battery is used, a controller for executing the request process needs to be prepared separately. In contrast, since the energy storage apparatus 1 includes the management part 55 for managing the energy storage device 12 and the management part 55 executes the request process, there is an advantage that the controller for executing the request process does not need to be provided separately.

According to the energy storage apparatus 1, the voltage drop ΔV during restart is estimated based on the current value, and the minimum voltage V1 is estimated by subtracting the voltage drop ΔV during restart from the open-circuit voltage V4 of the energy storage device 12 at the present time point. For example, it is conceivable to estimate the minimum voltage V1 by setting the voltage drop ΔV during restart to a fixed value and subtracting the voltage drop ΔV (fixed value) during restart from the open-circuit voltage V4 of the energy storage device 12 at the present time point. However, since the voltage drop ΔV during restart is not constant, when the voltage drop ΔV during restart is set to the fixed value, the estimation accuracy of the minimum voltage V1 decreases. According to the energy storage apparatus 1, the voltage drop ΔV during restart is estimated based on the current value, so that the minimum voltage V1 can be accurately estimated as compared to when the voltage drop ΔV during restart is set to a fixed value.

According to the energy storage apparatus 1, the open-circuit voltage V4 of the energy storage device 12 at the present time point is estimated based on the current value measured by the current sensor 51. As a method of knowing the open-circuit voltage V4 of the energy storage device 12 at the present time point, a method of actually opening the circuit and measuring the voltage of the energy storage device 12 can be considered. However, the energy storage device 12 needs to supply electric power to the auxiliaries during idling-stop, and hence the voltage cannot be measured by actually opening the circuit during idling-stop. According to the energy storage apparatus 1, the open-circuit voltage V4 is estimated based on the current value measured by the current sensor 51, rather than actually measuring the voltage by opening the circuit, so that the minimum voltage V1 can be estimated even when the open-circuit voltage cannot be measured during idling-stop.

According to the energy storage apparatus 1, the voltage drop ΔV during restart is estimated based on the voltage drop ΔV3 caused by the concentration polarization at the present time point, whereby the voltage drop ΔV during restart can be accurately estimated as compared to the case where the voltage drop ΔV during restart is not based on the voltage drop ΔV3 caused by the concentration polarization at the time point described above.

According to the energy storage apparatus 1, the energy storage device 12 is a lithium ion battery. The lithium ion battery has a large capacity (has a high energy density) and may thus supply electric power to many auxiliaries. Thus, the voltage drop of the lithium ion battery may become large due to power consumption by many auxiliaries during idling-stop. When the voltage drop becomes large, the engine may not be able to be restarted. When the engine cannot be restarted, the battery may be replaced. Lithium ion batteries are generally expensive, and hence the replacement of a lithium ion battery is typically not desired. According to the energy storage apparatus 1, when the minimum voltage V1 of the energy storage device 12 during the restart of the engine is less than the threshold V2, a restart request for the engine is notified to the idling-stop vehicle, so that the replacement of the lithium ion battery can be prevented. Since the lithium ion battery has the battery management apparatus 50, it is not necessary to separately develop and mount a monitoring substrate in implementing the present invention.

### OTHER EMBODIMENTS

The technique disclosed in the present specification is not limited to the embodiment described with reference to the above description and drawings, and for example, such embodiments as follows are also included in the technical scope disclosed in the present specification.

(1) In the above embodiment, the current value has been described as an example of the physical quantity relating to the voltage drop of the energy storage device 12, but the physical quantity is not limited to the current value. The physical quantity may be the OCV of the energy storage device 12. The management part 55 may obtain the open-circuit voltage V4 of the energy storage device 12 at the present time point by measuring the OCV.

The physical quantity may be the temperature of the energy storage device 12. As described above, the voltage drop caused by the resistance polarization and the activation polarization depends precisely on the temperature as well, and hence the voltage drop may be estimated by using the temperature.

(2) Although a lithium ion battery has been described as an example of the energy storage device in the above embodiment, the energy storage device may be a capacitor with an electrochemical reaction.

### DESCRIPTION OF REFERENCE SIGNS

1: energy storage apparatus
2: idling-stop vehicle
12: energy storage device
51: current sensor (example of measurement part)
52: voltage sensor (example of measurement part)
53: temperature sensor (example of measurement part)
55: management part

1. An energy storage apparatus for supplying electric power to auxiliaries and a starter that starts an engine of an idling-stop vehicle, the energy storage apparatus comprising:
an energy storage device;
a measurement part that measures a physical quantity relating to a voltage drop of the energy storage device; and
a management part that manages the energy storage device,
wherein the management part executes
an estimation process of estimating, based on the physical quantity, a minimum voltage of the energy storage device during restart of the engine at a predetermined time point during idling-stop of the idling-stop vehicle, and
a notification process of notifying a restart request for the engine to the idling-stop vehicle when the minimum voltage is less than a predetermined threshold.

2. The energy storage apparatus according to claim 1, wherein the measurement part and the management part are mounted on a circuit board unit provided in the energy storage apparatus to form a battery management apparatus.

3. The energy storage apparatus according to claim 1, wherein the management part estimates a voltage drop during the restart of the engine based on the physical quantity and estimates the minimum voltage by subtracting the voltage drop during the restart of the engine from an open-circuit voltage of the energy storage device at the time point.

4. The energy storage apparatus according to claim 3, wherein
the physical quantity includes a current value of a current flowing in the energy storage device, and
the management part estimates the open-circuit voltage of the energy storage device at the time point based on the current value measured by the measurement part in the estimation process.

5. The energy storage apparatus according to claim 3, wherein the management part estimates, in the estimation process, a voltage drop caused by concentration polarization of the energy storage device at the time point based on the physical quantity and estimates the voltage drop during the restart of the engine based on the estimated voltage drop caused by the concentration polarization of the energy storage device.

6. The energy storage apparatus according to claim 5, wherein the voltage drop caused by the concentration polarization is estimated using an internal resistance value of the energy storage device estimated by the management part.

7. The energy storage apparatus according to claim 1, wherein in the estimation process, the management part estimates the minimum voltage by subtracting, from the open-circuit voltage of the energy storage device at the time point, a voltage drop caused by current consumption of the starter during the restart of the engine and a voltage drop caused by polarization of the energy storage device during the restart of the engine.

8. The energy storage apparatus according to claim 1, wherein the energy storage device comprises a lithium ion battery.

9. A restart method of restarting an engine of an idling-stop vehicle provided with an energy storage apparatus for supplying electric power to auxiliaries and a starter that starts the engine of the idling-stop vehicle,
the energy storage apparatus including:
an energy storage device;
a measurement part that measures a physical quantity relating to a voltage drop of the energy storage device; and
a management part that manages the energy storage device,
the restart method comprising:
the management part estimating, based on the physical quantity, a minimum voltage of the energy storage device during the restart of the engine at a predetermined time point during idling-stop of the idling-stop vehicle, and
the management part notifying a restart request for the engine to the idling-stop vehicle when the minimum voltage is less than a predetermined threshold.

10. The method according to claim 9, wherein the management part estimates the minimum voltage by subtracting, from the open-circuit voltage of the energy storage device at the time point, a voltage drop caused by current consumption of the starter during the restart of the engine and a voltage drop caused by polarization of the energy storage device during the restart of the engine.
